(19) United States
(12) Patent Application Publication
(10) Pub. No.: US 2021/0064983 A1
(43) Pub. Date: Mar. 4, 2021

(54) MACHINE LEARNING FOR INDUSTRIAL PROCESSES

(71) Applicant: Canvass Analytics, Toronto (CA)

(72) Inventors: Mingjie Mai, Toronto (CA); Venkatesh Muthusamy, Toronto (CA); Steve Kludt, Toronto (CA)

(21) Appl. No.: 16/554,596

(22) Filed: Aug. 28, 2019

(51) Int. Cl. G06N 3/08; G06N 3/04; G06N 5/00; G05B 19/4155

(52) U.S. Cl. CPC G06N 3/08; G06N 3/04; F27D 2019/004; G05B 19/4155; G05B 2219/41054; G06N 5/003

(57) ABSTRACT

Methods and systems for training a neural network in tandem with a policy gradient that incorporates domain knowledge with historical data. Process constraints are incorporated into training through an action mask. Evaluation of the trained network is provided by comparing the network's recommended actions with those of an operator. A decision tree is provided to explain a path from an input of process states, into the neural network, to the output of recommended actions.

### BACKGROUND

Machine-learning (ML), including reinforcement learning (RL), is used to develop adaptive, data-driven predictive models that make inferences and decisions from real-time sensor data. Such models serve as key technologies of cognitive manufacturing. The “Internet of Things” (IoT) is a new technological foundation for connectivity, with real-time messaging of data coming from many sensors, devices, equipment and unit operations (stages) in complex manufacturing production processes.

US2007014293 5A1 discloses a method and arrangement in a computer system for controlling a process in which a process is described as a number of process variables and as process elements. Each process element includes a rule for transitioning to at least one other process element and actions to be performed when the process element is active. By making transition calculations to a new process state, based on actions and the rules, a process control system and method is provided that can handle most different kinds of processes and that can be executed with a limited amount of program code.

### BRIEF SUMMARY

ML and RL algorithms along with IoT, enable the development of an intelligent plant advisory system that can adaptively compute an optimal control set point. Various ML and RL techniques can be applied to develop an action scheduling agent that can compute an optimal control set point, along with its confidence for a complex manufacturing process. Such processes are difficult to model using first principle equations and, in many cases, involve multiple chemical and physical reactions including phase transition of materials.

In one aspect, there is provided a method comprising: obtaining training data of a process, the training data comprising information about a current process state, an action from a plurality of actions applied to the current process state, a next process state obtained by applying the action to the current process state, a reward based on a metric of the process, the reward depending on the current process state, the action, and the future process state; and a long-term reward comprising the reward and one or more future rewards; and training a neural network on the training data to provide a recommended probability of each action from the plurality of actions, wherein a policy gradient algorithm adjusts a raw action probability output by the neural network to the recommended probability by incorporating domain knowledge of the process.

In another aspect, there is provided a non-transitory computer-readable storage medium, the computer-readable storage medium including instructions that when executed by a computer, cause the computer to: obtain training data of a process, the training data comprising information about a current process state, an action from a plurality of actions applied to the current process state, a next process state obtained by applying the action to the current process state, a reward based on a metric of the process, the reward depending on the current process state, the action, and the future process state; and a long-term reward comprising the reward and one or more future rewards; and train a neural network on the training data to provide a recommended probability of each action from the plurality of actions, wherein a policy gradient algorithm adjusts a raw action probability output by the neural network to the recommended probability by incorporating domain knowledge of the process.

In yet another aspect, there is provided a computing system, the computing system comprising: a processor; and a memory storing instructions that, when executed by the processor, configure the system to: obtain training data of a process, the training data comprising information about a current process state, an action from a plurality of actions applied to the current process state, a next process state obtained by applying the action to the current process state, a reward based on a metric of the process, the reward depending on the current process state, the action, and the future process state; and a long-term reward comprising the reward and one or more future rewards; and train a neural network on the training data to provide a recommended probability of each action from the plurality of actions, wherein a policy gradient algorithm adjusts a raw action probability output by the neural network to the recommended probability by incorporating domain knowledge of the process.

In some embodiments, the policy gradient can incorporate an imaginary long-term reward of an augmented action to adjust the raw probability.

In some embodiments, the training data may further comprise one or more constraints on each action, with each constraint in the form of an action mask. In addition, the policy gradient incorporates an imaginary long-term reward of an augmented action and the one or more constraints to adjust the raw probability.

In some embodiments, the process is a blast furnace process for production of molten steel, the metric is a chemical composition metric of the molten steel, and the one or more recommended actions relate to operation of a fuel injection rate of the blast furnace.

In yet another aspect, there is provided a method for incorporation of a constraint on one or more actions in training of a reinforcement learning module, the method comprising application of an action mask to a probability of each action output by a neural network of the module.

In yet another aspect, there is provided a non-transitory computer-readable storage medium, the computer-readable storage medium including instructions that when executed by a computer, cause the computer to: incorporate a constraint on one or more actions during training of a reinforcement learning module by application of an action mask to a probability of each action output by a neural network of the module.

In yet another aspect, there is provided a computing system, the computing system comprising: a processor; and a memory storing instructions that, when executed by the processor, configure the system to application of an action mask to a probability of each action output by a neural network of the module.

In yet another aspect, there is provided a method comprising: providing an explanation path from an input to an output of a trained neural network comprising application of a decision tree classifier to the input and the output, wherein the input comprises a current process state and the output comprises an action.

In yet another aspect, there is provided a computing system, the computing system comprising: a processor; and a memory storing instructions that, when executed by the processor, configure the system to: provide an explanation path from an input to an output of a trained neural network by application of a decision tree classifier to the input and the output, wherein the input comprises a current process state and the output comprises an action.

In yet another aspect, there is provided a non-transitory computer-readable storage medium, the computer-readable storage medium including instructions that when executed by a computer, cause the computer to: provide an explanation path from an input to an output of a trained neural network comprising application of a decision tree classifier to the input and the output, wherein the input comprises a current process state and the output comprises an action.

In yet another aspect, there is provided a method for evaluating a reinforcement learning agent, the method comprising: partitioning a validation data set into two or more fixed time periods; for each period, evaluating a summary statistic of a metric for a process; and percentage of occurrences when an action of an operator matches an action of the agent; and correlating the summary statistic and percentage across all fixed time periods.

In yet another aspect, there is provided a non-transitory computer-readable storage medium, the computer-readable storage medium including instructions that when executed by a computer, cause the computer to: partition a validation data set into two or more fixed time periods; for each period, evaluate a summary statistic of a metric for a process; and percentage of occurrences when an action of an operator matches an action of the agent; and correlate the summary statistic and percentage across all fixed time periods.

In yet another aspect, there is provided a computing system, the computing system comprising: a processor; and a memory storing instructions that, when executed by the processor, configure the system to: partition a validation data set into two or more fixed time periods; for each period, evaluate a summary statistic of a metric for a process; and percentage of occurrences when an action of an operator matches an action of the agent; and correlate the summary statistic and percentage across all fixed time periods.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flow chart 100 in accordance with one embodiment.

FIG. 2 illustrates a time series cross validation in accordance with one embodiment.

FIG. 3 illustrates an action formulation 300 in accordance with one embodiment.

FIG. 4 illustrates an approach to deal with multiple continuous control parameters in accordance with one embodiment.

FIG. 5 illustrates a learning 500 in accordance with one embodiment.

FIG. 6 illustrates an overview of a deployment 600 in accordance with one embodiment.

FIG. 7 illustrates an action mode 700 in accordance with one embodiment.

FIG. 8 illustrates a period summary stats analysis in accordance with one embodiment.

FIG. 9 illustrates a simulated global policy analysis 900 in accordance with one embodiment.

FIG. 10 illustrates a control chart before and after deployment of an RL agent in accordance with one embodiment.

FIG. 11 illustrates a period summary stats analysis, using period summary statistics, for a blast furnace process, in which ores are mixed and combined into molten metal.

FIG. 12 illustrates a mapping 1200 in accordance with one embodiment.

Like reference numbers and designations in the various drawings indicate like elements.

FIG. 13 illustrates a simplified block diagram of a computing system in which various embodiments may be practiced.

### DETAILED DESCRIPTION

In the present disclosure, a complex manufacturing process is formulated for analysis by RL that trains, validates and deploys in real time in order to optimize the process using defined metrics by leveraging historically collected data and domain knowledge.

In an embodiment, historical data has been used, in conjunction with domain knowledge, to develop an RL agent that is deployed online for a metal-making blast furnace process. The RL agent is tasked to control the right amount of fuel to be injected into the process to obtain a desired temperature necessary for certain chemical processes to occur. A temperature that is too high or too low results in metal quality that is less than ideal. Chemical analysis is performed on the molten metal to determine the metal quality which is affected by the temperature of the process. That is, chemical analysis performed after the formation of the molten metal provides a measure of metal quality, which in turn, provides information on the process temperature. Since chemical analysis (of the manufactured molten metal) cannot be done instantaneously (i.e. in real time), the RL agent learns how to use relevant current information and past information and act without access to the true temperature within the blast furnace (which is too high to obtain reliably with sensors).

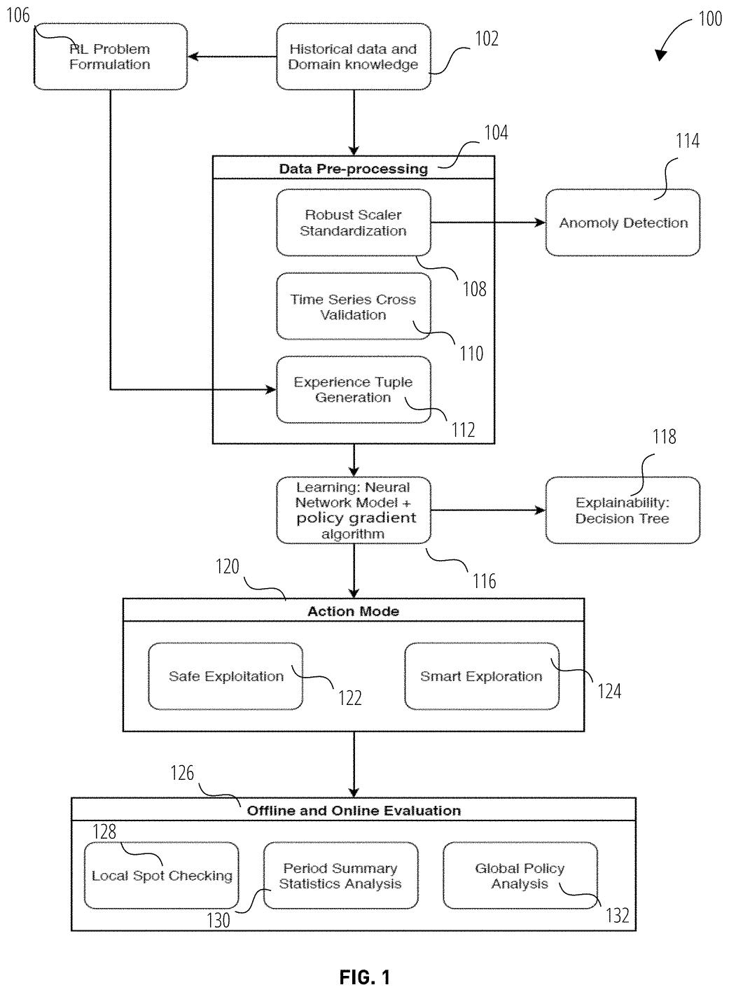

FIG. 1 illustrates a flow chart 100 in accordance with one embodiment.

Historical data and domain knowledge 102 are used to formulate the RL problem at 106. The data and knowledge at 102 are also pre-processed prior to input into the RL model. Data pre-processing 104 can include three modules: robust scaler standardization 108; time series cross validation 110 and experience tuple generation 112. Formulation of the RL problem (106) can be used to for experience tuple generation (112). In addition, robust scaler standardization 108 can be used to detect anomalies (box 114).

The pre-processed data is used to train a neural network model in conjunction with a policy gradient algorithm (116). The trained model can then be mapped onto a decision tree (118) for further understanding of the trained model.

The trained model is then ready for action mode 120, which can include two modes: safe exploitation mode 122 and smart exploration mode 124.

Following the action mode 120, offline and online evaluation of the trained model are preformed (126). This can include local spot checking (128), period summary statistics analysis (130) and global policy analysis (132).

In some embodiments, simulated data (obtained from a simulator of the process) can be used for training.

In some embodiments, a combination of simulated data and historical data can be used to train the neural network model in conjunction with the policy gradient.

A number of the elements shown in FIG. 1 are discussed further below.

Data Preprocessing

Robust Scaler Standardization and Anomaly Detection

Standardization of a dataset is a common requirement for many ML estimators. Typically, this is done by removing the mean and scaling to unit variance. However, outliers can often influence the sample mean/variance in a negative way. In response, a robust scaler can be used which centers and scales data using statistics that are robust to outliers. A robust scaler removes the median and scales the data according to the interquartile range (IQR) independently on each feature. The IQR is the range between the 1st quartile (25th percentile) and the 3rd quartile (75th percentile). This standardization technique may also serve as a first debugging tool when strange or unconfident predictions are observed as the agent is deployed online. For example, data from a malfunctioning sensor becomes very positive or very negative after applying use of robust scaler.

Time Series Cross Validation

Offline results can be generalized to online production by use of time-series cross validation to split the historical data. The original historical data is partitioned into 3 sets: an initial training set 202; a rolling validation set 204; and a rolling test set 206.

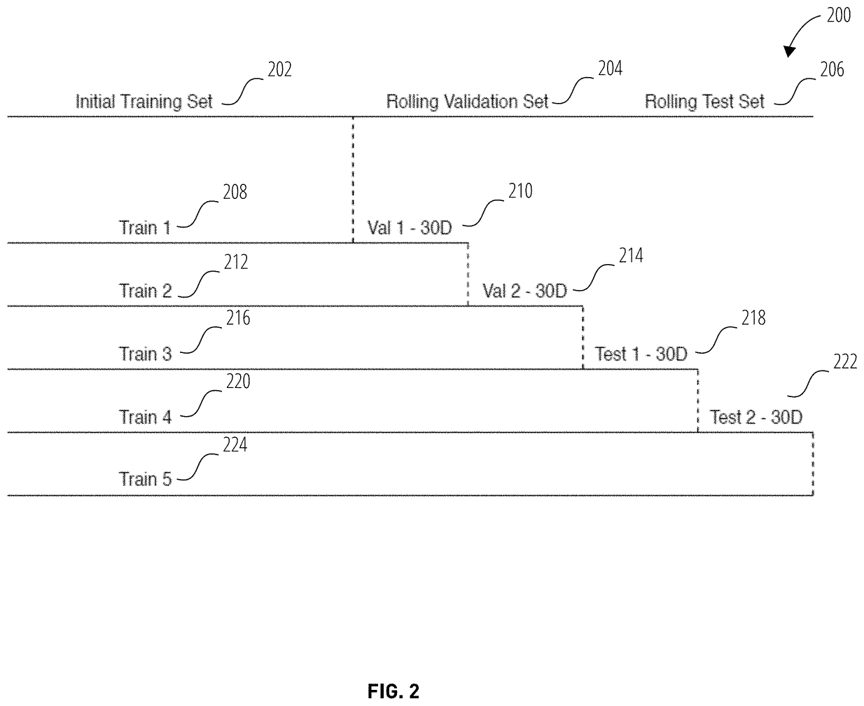

FIG. 2 illustrates a time series cross validation 200 in accordance with one embodiment. The original historical data is partitioned into 3 sets: an initial training set; a validation set; and a test set.

For example, suppose the RL model is retrained every 30 days. The initial training set 202 is used to train the model a first time (Train 1 208), which then undergoes a first validation (Val 1 210) in the next 30-day window, to finetune the hyperparameters.

The model is trained a second time (Train 2 212) using the same hyperparameters obtained from Val 1 210, and combined historical data from the initial training set 202 and the first additional 30 days (that were used for Val 1 210). The second training (Train 2 212) is then validated (Val 2 214) using data from a second additional period of 30 days. The performance of the model in the rolling validation set is used to tune hyperparameters of the model. In some embodiments, the hyperparameter is fine tuned based on validation 1 and validation 2 results (e.g. average/median)—in which case, the same hyperparameter is used for Train 1 208 and Train 2 212. Multiple iterations may have been run on Train 1 208 and Train 2 212 to determine which hyperparameter is the most suitable.

After the hyperparameter is fined tune based on Val 1 210 and Val 2 214, the best set of hyperparameters may be used on Test 1 218 and Test 2 222.

The model can be trained a third time (Train 2 212) using the same hyperparameters obtained from Val 2 214, and the combined historical data from the initial training set 202, the first additional 30 days (that were used for Val 1 210) and the second additional 30 days (that were used for Val 2 214). The third training (Train 3 216) is then tested for the first time (Test 1 218) using data from a third additional period of 30 days.

The model is trained a fourth time (Train 4 220) using the same hyperparameters obtained from Val 2 214, and the combined historical data from the initial training set 202, the first additional 90 days of data beyond. The fourth training (Train 4 220 is then tested for the second time (Test 2 222) using data from a fourth additional period of 30 days.

The model is trained a fifth time (Train 5 224) using the same hyperparameters obtained from Val 2 214, and the combined historical data from the initial training set 202, the first additional 120 days of data beyond. The fifth training model (Train 5 224) is then the RL model.

In addition, the stability of the algorithm may be observed by using different random seeds. The best hyperparameters can then be applied on the rolling test set before pushing the agent online.

While FIG. 2 illustrates two sets of rolling validations and two sets of rolling tests, it is understood that fewer or more rolling validations and/or rolling tests may be used. That is, the model may be trained fewer than, or more than five times.

RL Problem Formulation

A continuous control problem can be formulated as a RL problem. The goal of an RL agent is to observe the current state, then schedule an action at each decision time point that results in a high long-term reward. The RL agent may make a short-term sacrifice in order to obtain a larger future reward. Based on the nature of the business use case, appropriate definitions can be set for decision time, state action, action mask and reward function. For example, a “decision time” t is the time at which the agent performs a set point recommendation. The agent can decide every 5 minutes, every hour, or every week, or any other suitable time interval. Alternatively, the agent may not use a fixed interval, but instead, can recommend an action at one or more particular events (e.g. when a quality measure is made).

The state, Sₜ, is a vector representation of the process status. It captures the status at the current time t, or even past times [t−k, . . . , t−1] to capture any important temporal relationship.

An action. aₜ, is a set point scheduled by an actual operator or the RL agent. The action can also be defined as an increase, a decrease or no change from the current set point. The set point can be a continuous or a discrete control variable. For continuous control variables (e.g. such as temperature, humidity, etc.), the range of the set point can first be discretized into bins, and then the bins are treated as discrete actions.

Continuous Set Points

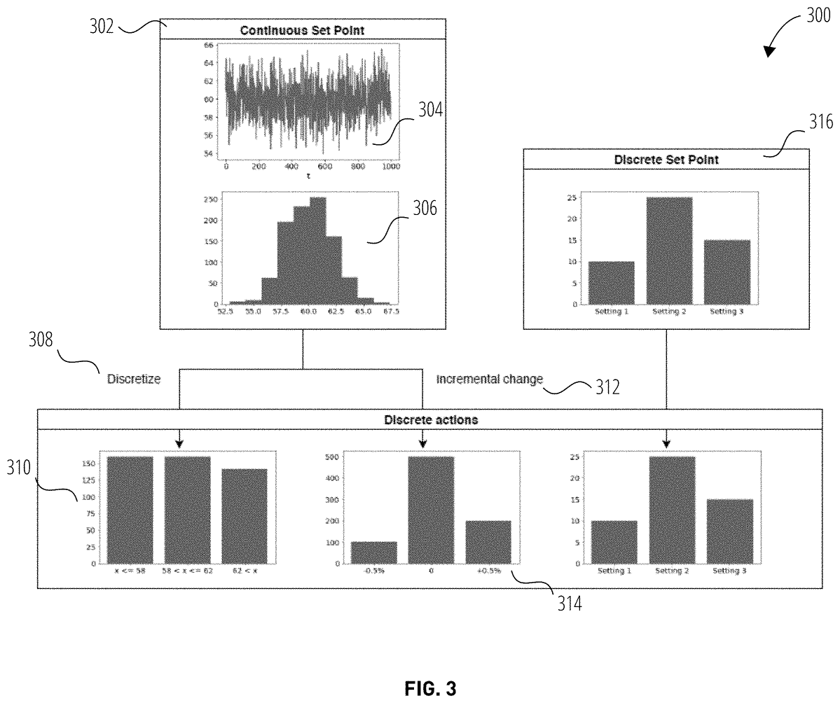

FIG. 3 illustrates a technique that may be used to convert continuous set points 302 to discrete actions. For example, a temperature reading may be represented by the graph 304. A histogram of the graph 304 is represented by 306. The continuous temperature settings are converted into discrete actions as part of the RL problem formulation.

Conversion may be implemented in a number of ways. In FIG. 3, two ways are shown (although other ways are possible). One way is to discretize (308) the continuous readings into a series of intervals that cover the range of the readings. This is shown in bar chart 310, in which the readings are divided into three intervals. In 310, the temperature readings (in graph 304) are divided into the following intervals: less than or equal to 58; between 58 and 62; and greater than 62. The number of intervals equals the number of actions. While three actions are shown in 310, it is understood that there can be more or fewer than three.

Another way to convert continuous set points into a set of discrete actions is to distribute readings according to incremental change 312. In bar chart 314, three intervals are shown (although there can be fewer or more), which define actions relative to a current set point. The bar at ‘0’, signifies no change; the bar at +0.5% indicates an upward shift of 0.5%; and the bar at −0.5% indicates an upward shift of −0.5%. Similar to 310, bar chart 314 can have more or fewer intervals than three (e.g. +1%, −1%, +2%, −2%, etc.).

Item 316 shows the situation where a discrete set point already exists within the historical data, in which three settings are shown (again, there can be fewer or more). There is no need to perform any discretization for the situation shown in 316.

Multiple Continuous Set Points

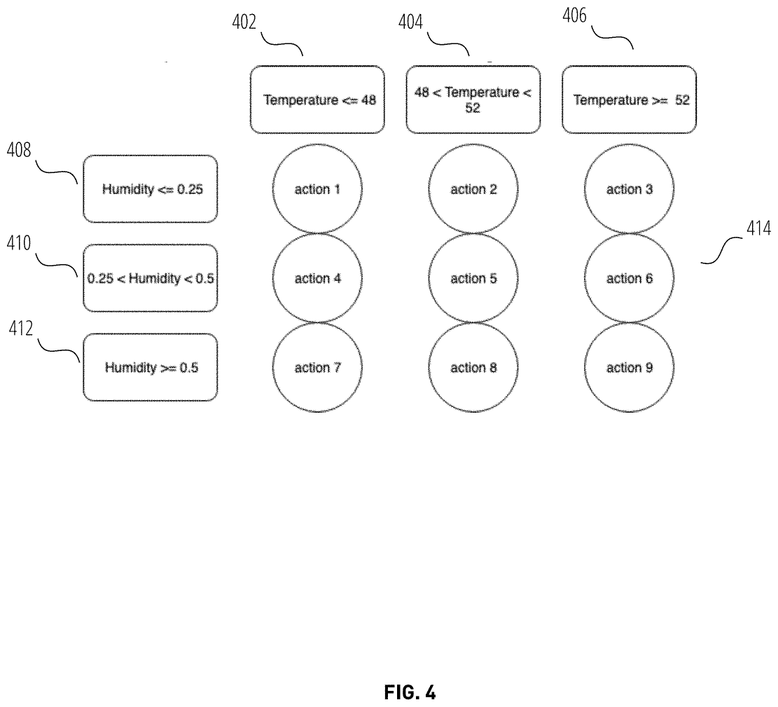

Multiple continuous set points may be handled in a manner analogous to that shown in FIG. 3. For example, continuous set points for both temperature and humidity can be converted to a set of actions in accordance with an embodiment shown in FIG. 4. Three intervals can be set for each entity. All combinations of the different intervals result in a total number of nine actions to be scheduled.

In FIG. 4, the temperature intervals have been set as: less than or equal to 48 (402); between 48 and 52 (404); and greater than or equal to 52 (406). The humidity intervals have been set as: less than or equal to 0.25 (408); between 0.25 and 0.50 (410); and greater than or equal to 0.5 (412). This results in the nine actions a₁-a₉ (414). Another approach is to first schedule the temperature, then schedule the humidity later, and only assign reward after scheduling both types of actions.

The set of all possible actions that an agent can perform at the decision time is defined as the action space, Aₜ, of the agent. Based on the nature of the use case, Aₜ, can be time-dependent and/or context-dependent. That is, Aₜ may be constrained. One way to constrain Aₜ is by use of a time-dependent action mask mₜ. A binary action mask may impose a hard constraint on what the agent can or cannot schedule at each time point. On the other hand, a probability action mask may be used for a soft constraint which incorporates human domain knowledge. The action mask is discussed in further detail below.

A time-dependent reward function r(sₜ, sₜ₊₁, aₜ) signifies whether the action aₜ is ‘good’ or ‘bad’ based on the current status sₜ, or future status sₜ₊₁, of the process. It can return a real value or binary value. Usually, whether a state/action is good or bad can be quantified by one or more metrics. In an example of a complex manufacturing process, the one or metrics may be yield, quality of the products, system downtime, etc. These metrics may be present at each decision time but can also come at a different time interval. Furthermore, linear or non-linear combinations of these metrics can be used to derive a reward function. The reward function is used to encourage the RL agent to learn the operator's good behavior; it also teaches the RL agent to avoid making the operator's mistakes.

Long-term reward, Rₜ, is the cumulative reward that the agent receives from the current time point (at time=t) up to a decision point h intervals later (i.e. at time=t+h). That is, ‘h’ is the horizon. The long-term reward, Rₜ, can be discounted by a time-dependent factor γₜ, to weigh the relative importance of a current reward versus a future reward, i.e.

Rₜ=Σ_{t′=t}^{t+h}γₜ,r(s_{t′},s_{t′+1},a_{t′})

The horizon, h, represents how far the agent should focus into the future. The horizon affects the long-term reward assigned to an action.

Experience Tuple Generation from Historical Data

Based on the problem formulation, the historical data can be processed into experience tuple that contains: the current process state sₜ, the operator action aₜ, next process state sₜ₊₁, and a reward calculated using sₜ, sₜ₊₁ and aₜ. The long term reward Rₜ can be further calculated using a subsequent future reward.

An example of processed historical data (used to train the RL agent) is illustrated in Table 1, in which a horizon of 3 is used.

TABLE 1
Learning without augmented experience

| Decision | | Action | | | Long Term |
|---|---|---|---|---|---|
| Time | Current Process State | Made | Next Process State | Reward | Reward |
| t | Sₜ | aₜ | Sₜ₊₁ | rₜ | Rₜ |
| | [S_{t, 1}, S_{t, 2}, . . . S_{t, p}] | | [S_{t+1, 1}, S_{t+1, 2}, . . . , | r(Sₜ, Sₜ₊₁) | Σₜ_{^{′}}₌ₗ^{l+h} γrₜ_{^{′}} |
| | | | S_{t+1, p}] | | |
| 11:03 | [1, . . . , 1] | 2 | [2, . . . , 1] | 0.2 | 0.2 + 0.5 − 0.2 = 0.5 |
| 11:04 | [2, . . . , 1] | 1 | [2, . . . , 2] | 0.5 | 0.5 − 0.2 + . . . |
| 11:05 | [2, . . . , 2] | 3 | [3, . . . , 2] | −0.2 | −0.2 + . . . |
| . . . | . . . | . . . | . . . | . . . | . . . |

Action Mask

To optimize a control variable in an industrial process, the agent can suggest any action from the sample space of available actions. For example, if the temperature control has a sample space of five values: [low, low-med, med, med-high, high], the agent can suggest any one of the actions from the sample space. However, there may be one or more variable constraints on the process, such that during certain conditions, the temperature cannot change more than one step (e.g. from low to med, or low to high, or low-med to med-high, etc.), whereas in certain conditions, a change of more than one step may be allowed. This is an example of a context-dependent constraint. It may not be feasible to retrain the agent for each of the cases of variable constraints.

To ensure that the variable process constraints are accommodated from a single trained agent, the results of the agent (i.e. the raw probability generated by the neural network) can be manipulated through an action mask. The action mask may be a vector of binary numbers with the same dimension as the vector of agent probability predictions. An action mask vector can be calculated based using a function that converts the constraints for a current operating state into a mask vector. The action mask vector is then multiplied with the agent predictions, which will generate an action prediction based on the context-dependent constraint.

For example, where three actions are possible at a time point, a binary mask may take the form [0, 1, 0]—which means only action 2 is available to the agent at the current decision time. That is, the elements of a binary mask are either ‘0’ or ‘1’. An example of a soft probability mask, [0.1, 0.8, 0.1], means that action 1 and action 3 are still possible, but only occur if the agent is highly confident.

Table 2 shows the action recommendation from the agent without an action mask. While using an agent mask, the agent's predicted probabilities are multiplied with the action mask and the new probabilities are obtained as shown in Table 3. The agent action recommendations are then based on the masked action probability.

TABLE 2
Inference without action mask

| Decision Time t | Agent Action probability pₜ | Agent Action |
|---|---|---|
| | [p_{t, 1}, p_{t, 2}, . . . , p_{t, q}] | f(pₜ) = \argmaxp(t) |
| 11:03 | [0.7, 0.2, 0.1] | 1 |
| 11:04 | [0.4, 0.1, 0.5] | 3 |
| 11:05 | [0.2, 0.3, 0.5] | 3 |
| . . . | . . . | . . . |

TABLE 3
Inference with action mask

| Decision | Agent Action | Action | Possible | Masked Action | |
|---|---|---|---|---|---|
| Time t | probability pₜ | mask mₜ | Actions | Probability pₜ^{′} | Agent Action |
| | [p_{t, 1}, p_{t, 2}, . . . , | [m_{t, 1}, | | [p_{t, 1}m_{t, 1}, p_{t, 2}m_{t, 2}, | f(pₜ^{′}) = \argmaxpₜ^{′} |
| | p_{t, q}] | m_{t, 2}, . . . , | | . . . p_{t, k} m_{t, q}] | |
| | | m_{t, q}] | | | |
| 11:03 | [0.7, 0.2, 0.1] | [0, 1, 0] | 2 | [0, 0.2, 0] | 2 |
| 11:04 | [0.4, 0.1, 0.5] | [1, 1, 0] | 1, 2 | [0.4, 0.1, 0] | 1 |
| 11:05 | [0.2, 0.3, 0.5] | [1, 1, 1] | 1, 2, 3 | [0.2, 0.3, 0.5] | 3 |
| . . . | . . . | . . . | . . . | . . . | . . . |

As can be seen from the results of Table 2 and Table 3, an action mask can alter the agent's recommended action.

An action mask can include a number of variations.

For example, the action mask can include continuous numbers (i.e. a probability or ‘soft’ action mask) instead of binary numbers (i.e. a binary action mask)—in cases where considerations need to be given to all of the agent's predicted probabilities. This enables any risks associated with discarding a particular action.

The action mask can also be temporally varied for temporal-dependent constraints. For example, an action mask can be calculated differently based on seasonality, the time of the day, the time of month, etc. This technique can be applied to any process where constraints need to be added to agent predictions to meet certain criteria. For example, in auto investing, different action masks can be used for different risks of investment.

The action mask can also be incorporated as a state variable so that the agent can learn the real-time constraints as part of training the model.

Augmentation of Data Based on Domain Knowledge

The timestep of data with non-optimal/bad actions can be changed to a good action and used for agent training if the good action for the given timestep can be inferred from domain knowledge.

As an example, consider setting a home temperature. Setting the home temperature above comfortable levels will increase the temperature of the house to a higher value than desired. This is a bad action. If the domain knowledge is known, for the same instance of data, a derived augmented data (based on domain knowledge) can be generated by changing the action from a bad value of high temperature to a good value of ambient temperature.

Table 1 shows an example of training dataset with a few actions. However, there are not enough state-action pairs being observed by the agent, since there is at most one action applied to the state at a given timestamp. It is possible to augment the data, using domain knowledge. The corresponding augmented data can be generated by changing actions with a negative reward (i.e. “bad” actions) into actions with a positive reward (i.e. “good” actions) and an imaginary reward for the corresponding data, as shown in Table 4.

TABLE 4
Learning with Augmented Experience (no action mask)

| | | | Next | | | |
|---|---|---|---|---|---|---|
| | Current | Action | Process | | Long | Imaginary |
| Decision | Process | Made | State | Reward | Term Reward | Long Term |
| Time t | State Sₜ | aₜ | Sₜ₊₁ | rₜ | Rₜ | Reward Rₜ^{′} |
| | [S_{t, 1}, | | [S_{t+1, 1}, | R(Sₜ, | Σₜ_{^{′}}₌ₜ^{1+h} γₜ_{^{′}}rₜ_{^{′}} | f(Rₜ, |
| | S_{t, 2}, | | S_{t+1, 2}, . . . , | Sₜ₊₁, | | Sₜ, |
| | . . . S_{t, p}] | | S_{t+1, p}] | aₜ) | | Sₜ₊₁, aₜ) |
| 11:03 | [1, . . . , 1] | 2 | [2, . . . , 1] | 0.2 | 0.2 + 0.5 − | NA |
| | | | | | 0.2 = 0.5 | |
| 11:03 | [1, . . . , 1] | 1 | NA | NA | NA | 0.5 * 3 = 1.5 |
| (Augmented) | | | | | | |
| 11:03 | [1, . . . , 1] | 3 | NA | NA | NA | 0.5 * −3 = −1.5 |
| (Augmented) | | | | | | |
| 11:04 | [2, . . . , 1] | 1 | [2, . . . , 2] | 0.5 | 0.5 − 0.2 + . . . | NA |
| 11:04 | [2, . . . , 1] | 2 | NA | NA | NA | . . . |
| (Augmented) | | | | | | |
| 11:04 | [2, . . . , 1] | 3 | NA | NA | NA | . . . |
| (Augmented) | | | | | | |
| 11:05 | [2, . . . , 2] | 3 | [3, . . . , 2] | −0.2 | −0.2 + . . . | NA |
| 11:05 | [2, . . . , 2] | 1 | NA | NA | NA | . . . |
| (Augmented( | | | | | | |
| 11:05 | [2, . . . , 2] | 2 | NA | NA | NA | . . . |
| (Augmented) | | | | | | |
| . . . | . . . | . . . | . . . | . . . | . . . | . . . |

In the example shown in Table 4, an augmented experience is evaluated at each time step.

For example, at 11:03, the operator has acted using action 2 on current state [1, . . . , 1], resulting in a next process state of [2, . . . , 1] at 11:04. This action has a reward of 0.2. Since action 2 is the actual action being taken at 11:03, the augmented action at 11:03 includes both action 1 and action 3. Based on future information (e.g. at 11:04), action 1 could have received a higher long-term reward. Similarly, action 3 at 11:03 could have received a lower long-term reward, based on future information. The imaginary reward shown in the last column is generated based on the long-term reward of actual action 2 at 11:03 (i.e. 0.5) and then scaled by a factor based on whether a better or worse long term reward could have been received.

In some embodiments, for low positive or negative reward, domain knowledge may be applied to determine which action would have been better, and which action would have been even worse. If an action would have been better, the absolute actual long term reward can be scaled by a positive number. On the other hand, for the worse action, the absolute actual long term reward can be scaled by negative number.

At 11:04, the operator has acted using action 1, resulting in a next process state of [2, . . . , 2]. This action has a reward of +0.5. Since action 1 is the actual action being taken at 11:04, the augmented action at 11:04 includes action 2 and action 3.

At 11:05, the operator has acted using action 3, resulting in a next process state [3, . . . , 2]. This action has a reward of −0.2. Since action 3 is the actual action being taken at 11:05, the augmented action at 11:05 includes action 1 and action 2.

There are many possible variations of the augmented data method. For example, it can also be used to add bad action examples and help increase the sample size of training data from the historical data. This can help the model balance the data between good and bad examples.

In addition, this technique can also be used to add more data samples by changing both the states and actions for handling the edge cases of process which may otherwise be unavailable in historical data.

Furthermore, this technique can be used for applications in which rules can be added as augmented data. Examples of such applications include stock price prediction where financial rules can be added (as augmented data).

In another possible variation, whether an experience is augmented can also be incorporated as a state variable so that the agent can learn the difference between real and augmented experiences.

In another variation, where simulated data is used, the augmented action and imaginary long-term reward can be obtained from data generated by the simulator.

Another possible variation includes the use of an action mask with this technique, which is discussed below.

Learning with Augmented Experience and Action Mask

An action mask can be used in conjunction with the augmented experience, to limit the possible actions taken by the agent and reduce training time. For example, Table 5 shows an example of an action mask at different times:

TABLE 5

| Decision Time t | Action mask mₜ |
|---|---|
| | [m_{t, 1}, m_{t, 2}, . . . m_{t, q}] |
| 11:03 | [0, 1, 0] |
| 11:04 | [1, 1, 0] |
| 11:05 | [1, 1, 1] |
| . . . | . . . |

According to Table 5, at 11:03, the action mask constrains the action chosen by the agent to action 2; at 11:04, action 1 or action 2 may be chosen by the agent; and at 11:05, all three actions can be employed. As a result, the augmented experience data of Table 4 is constrained to include only those actions allowed by the action mask. The new learning time series is shown in Table 6:

TABLE 6
Original experience and augmented experience (with action mask)

| | | | Next | | | |
|---|---|---|---|---|---|---|
| | Current | Action | Process | | Long | Imaginary |
| Decision | Process | Made | State | Reward | Term Reward | Long Term |
| Time t | State Sₜ | aₜ | Sₜ₊₁ | rₜ | Rₜ | Reward Rₜ^{′} |
| | [S_{t, 1}, | | [S_{t+1, 1}, | R(Sₜ, | Σₜ_{^{′}}₌ₜ^{1+h} γₜ_{^{′}}rₜ_{^{′}} | f(Rₜ, |
| | S_{t, 2}, | | S_{t+1, 2}, . . . , | Sₜ₊₁, | | Sₜ, |
| | . . . S_{t, p}] | | S_{t+1, p}] | aₜ) | | Sₜ₊₁, aₜ) |
| 11:03 | [1, . . . , 1] | 2 | [2, . . . , 1] | 0.2 | 0.2 + 0.5 − | NA |
| | | | | | 0.2 = 0.5 | |
| 11:04 | [2, . . . , 1] | 1 | [2, . . . , 2] | 0.5 | 0.5 − 0.2 + . . . | NA |
| 11:04 | [2, . . . , 1] | 2 | NA | NA | NA | . . . |
| (Augmented) | | | | | | |
| 11:05 | [2, . . . , 2] | 3 | [3, . . . , 2] | −0.2 | −0.2 + . . . | NA |
| 11:05 | [2, . . . , 2] | 1 | NA | NA | NA | . . . |
| (Augmented | | | | | | |
| 11:05 | [2, . . . , 2] | 2 | NA | NA | NA | . . . |
| (Augmented | | | | | | |
| . . . | . . . | . . . | . . . | . . . | . . . | . . . |

In Table 6, it is seen that the augmented experience at 11:04 only includes action 2, since the action mask allows for action 1 (which has already been taken by the operator) and action 2. At 11:05, the augmented data includes action 1 and action 2.

In summary, the experience tuples in either Table 1 (no augmentation, no masking). Table 4 (augmentation, no masking) or Table 6 (augmentation with masking) can be provided to the agent for training. In some embodiments, experience tuples with augmentation, without masking, are used to train the agent. In some embodiment, experience tuples with augmentation and masking are used to train the agent.

Learning: Neural Network Model and Policy Gradient

In an embodiment, a multi-class neural network model and a policy gradient algorithm are employed to learn optimal actions. Non-limiting examples of multi-class neural network models include convolution-neural-networks (CNN), recurrent neural networks (RNN), Multilayer perceptron (MLP), any variation of CNN and RNN such as ResNet, LSTM-RNN, GRU-RNN, etc. Non-limiting examples of a policy gradient algorithm include algorithms such as REINFORCE™, Actor-Critic, Off-Policy Policy Gradient, Asynchronous Advantage Actor-Critic (A3C) and Synchronous Advantage Actor-Critic (A2C).

The model takes the current state (and optionally the action mask) as input, and outputs probabilities for all possible actions. The neural network can capture complex non-linear dynamics and generalize the relationship between state and action to unseen cases. The RL agent learns to behave like the best operator using the policy gradient. Intuitively, the algorithm increases the probability corresponding to a state if an action lead to a positive long-term reward in the historical data. At the same time, it decreases the probability of scheduling other actions that lead to a negative long-term reward in the historical data. On the other hand, the algorithm decreases the probability of a bad action and increases the probability of all other actions.

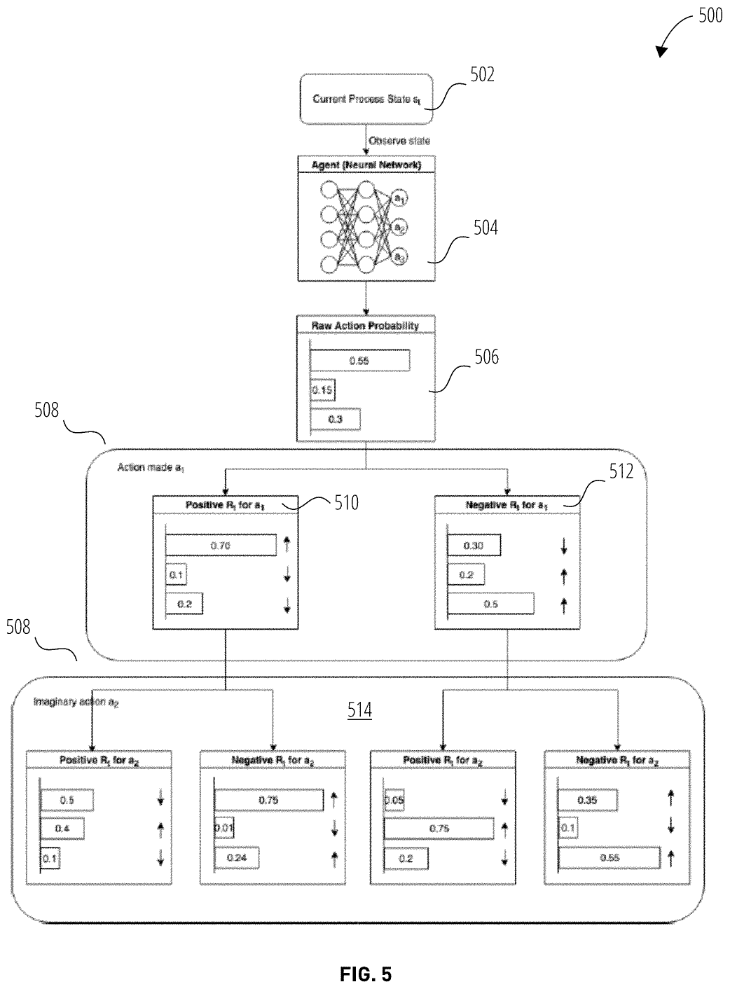

FIG. 5 illustrates an example of how the RL model perceives the augmented data, where the augmented data generates a different probability than the original data action probability.

Initially, the neural network or agent 504 observes the current state 502 and provides the raw probabilities of the possible actions at 506. The policy gradient algorithm 508, then uses the long-term reward Rₜ, to determine new action probabilities. In the example shown in FIG. 5, action 1 was taken by operator; if the long-term reward of Rₜ of a₁ is positive, then the policy gradient algorithm 508 will adjust the weights within the neural network (or agent) 504 to increase the probability of a₁, while decreasing those of the remaining actions (as shown in 510). On the other hand, if Rₜ of a₁ is negative, then the policy gradient algorithm 508 will adjust the weights within the neural network (or agent) 504 to decrease the probability of a₁, while increasing those of the remaining actions (as shown in 512).

In addition, at the current time-step, the policy gradient algorithm 508 will incorporate the augmentation data of action a₂ and adjust the weights of the neural network (or agent 508) depending on whether the imaginary long-term reward for augmented action a₂ is positive or negative, as shown in 514. A total of four possible augmented sets of probabilities are calculated: (Rₜ of a₁>0; Rₜ of a₂>0); (Rₜ of a₁>0; Rₜ of a₂<0); (Rₜ of a₁<0; Rₜ of a₂>0); and (Rₜ of a₁<0; Rₜ of a₂<0). An augmented data set for action a₃ can also be calculated, provided a masking agent does not prohibit its possibility. The set of each probabilities is reflected by the weight adjustments performed on the neural network (or agent) 504 by the policy gradient algorithm 508.

Unlike traditional use of algorithms, this method integrates historical data with domain knowledge in the RL model. Domain knowledge provides information that an action can be better or worse based on a future state (which is done when training using retrospective data). This information can be leveraged to increase the probability of better actions or decrease the probability of worse actions, rather than arbitrarily increase the probability of all the other actions.

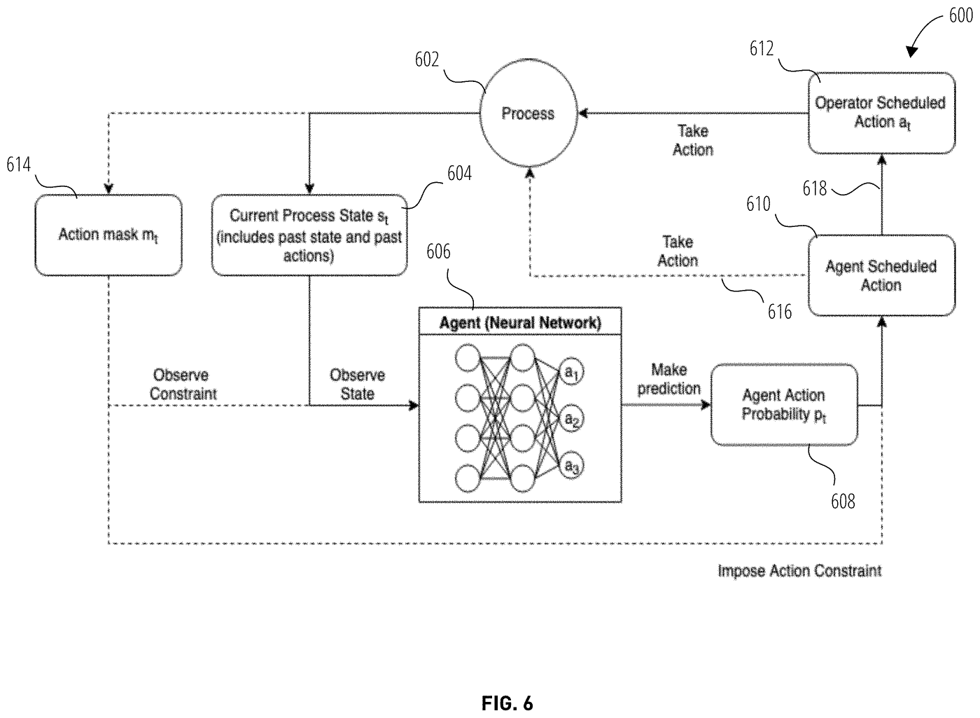

FIG. 6 illustrates an overview of a deployment 600 of agent 606 in accordance with one embodiment.

At decision time t, the process 602 presents to the agent 606 its current process states 604 (which may include past state information and past actions performed on the process). The agent (as a neural network classifier) generates a probability distribution, pₜ, over all possible actions (item 608). Based on human-defined action mode, the agent recommends an action to be scheduled (item 610). The human operator can take the agent's recommended action (at step 618) and use human knowledge to decide whether to follow agent's action or take another action. The operator's scheduled action, aₜ, (item 612) is then acted on the process 602. The flow of events continues and moves to decision time t+1. Alternatively, the Scheduled Action (item 610) can interact directly with the process (step 616).

Optionally, the process can supply the agent an action mask mₜ 614. The optional nature of using an action mask is indicated by the dotted lines in FIG. 6. The agent 606 observes the real-time operating constraints, along with the states 604, to make a prediction. Furthermore, the mask mₜ 614 imposes an action constraint by multiplying with the probability pₜ (item 608), which generates a modified agent scheduled action item 610.

Action Mode: Safe Exploitation and Smart Exploration

Once the RL agent masters the actions of a “perfect” human operator, there is an option to switch the agent to smart exploration mode.

The neural network architecture provides a probability distribution for all possible actions. For example, suppose there are two possible actions: aₜ€{a₁:0.6; a₂:0.4}. In exploitation mode, the agent recommends the action with the highest probability (in this example, a₁). In a critical case (e.g. where each action that the agent schedules is crucial and can possibly break the machine/process), there can be a threshold on the probability, such that the RL agent can be trusted, and all of the top recommended actions can be presented to a human operator. An example of a critical case is controlling the steering of a car which is a critical task—each recommended action needs to have a high confidence level. An example of a non-critical case is changing a home thermostat by 2 degrees; small errors in the task will not result in destruction of the home. As an example of using a threshold, only scheduled actions that have a probability greater than 0.5 are recommend to the user; actions with a probability lower than 0.5 would not be recommended. This threshold again can be tuned according to evaluation methods (discussed further below).

In the smart exploration mode, the agent recommends actions according to a probability distribution of the actions. In the example above, the agent recommends action a₁ with a probability of 60%, and action a₂ with a probability of 40%. The magnitude of exploration can be controlled by transforming the raw probability and can optionally ignore actions with very low probability.

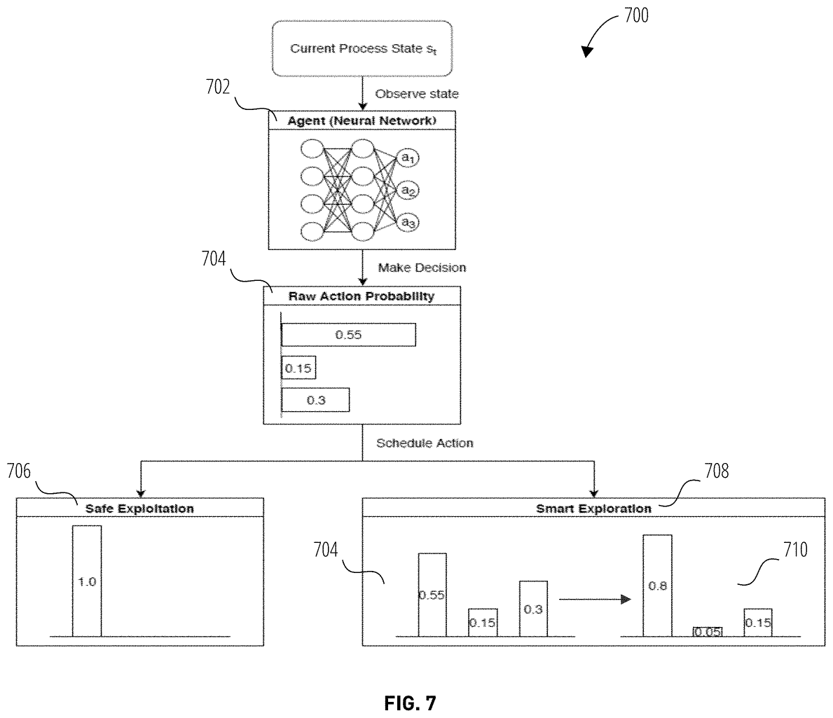

FIG. 7 illustrates an action mode 700 in accordance with one embodiment. The agent 702 makes a preliminary decision by providing a raw action probability 704 (i.e. the probability from the neural network without any modification) of 3 possible actions: a₁ has a raw probability of 55%; a₂ has a raw probability of 15%; and a₃ has a raw probability of 30%. The action is non-deterministic and is sampled from the distribution to take action. The scheduled action will depend on whether safe exploitation mode 706 is selected or smart exploration mode 708 is selected. If safe exploitation mode 706 is chosen, then the action with the highest raw probability (i.e. a₁ᵢ) is only selected, with a probability of 1.

On the other hand, in smart exploration mode 708, one does not simply use the action with the largest probability. Instead, there is sampling from the probability distribution. If smart exploration mode 708 is selected, the raw action probabilities are transformed from raw action probability 704 to item 710. That is, the transformation can be made according to known methods in the art. As an example, the raw probability can be scaled by a factor, then passed to a SoftMax to return a probability mass. In this way, there is exploration, but the overall process is still safe.

Offline and Online Evaluation

The system is evaluated before applying it online. As discussed above, only one action can be performed on a given state. There is no concrete knowledge of what would happen if another action were taken, nor knowledge of what the long-term impact of this other action is. Traditionally, a simulator is constructed for the process, in order to see what happens if another policy (or set of actions) is deployed on the process. A drawback of this approach is that the simulator is often difficult to build, or it may not mimic the real process accurately. Another concern with using a simulator is that it often takes a long time to generate one simulation (e.g., in physical models such as continuous fluid dynamics, a thermodynamics model or a structural model). Another traditional approach is to bring it online and perform A/B testing if possible.

In some embodiments, there is provided a robust guideline to build a confident agent prior to pushing it online, and also to evaluate its performance in online production. The method may be diagnosed and evaluated using three methods on an offline validation set and later, the same three methods on an online validation set.

Local Spot Checking The first method is intuitive spot checking. Using domain knowledge, one can manually inspect and try to understand whether a control policy make sense.

Period Summary Statistics Analysis The validation set data can be partitioned into two or more fixed time periods. The length of the time period depends on the nature of the use case and is larger than a pre-defined horizon. For each period, there is calculation of summary statistics of metrics of interest and the percentage of time that the operator's actions and the agent's actions matched.

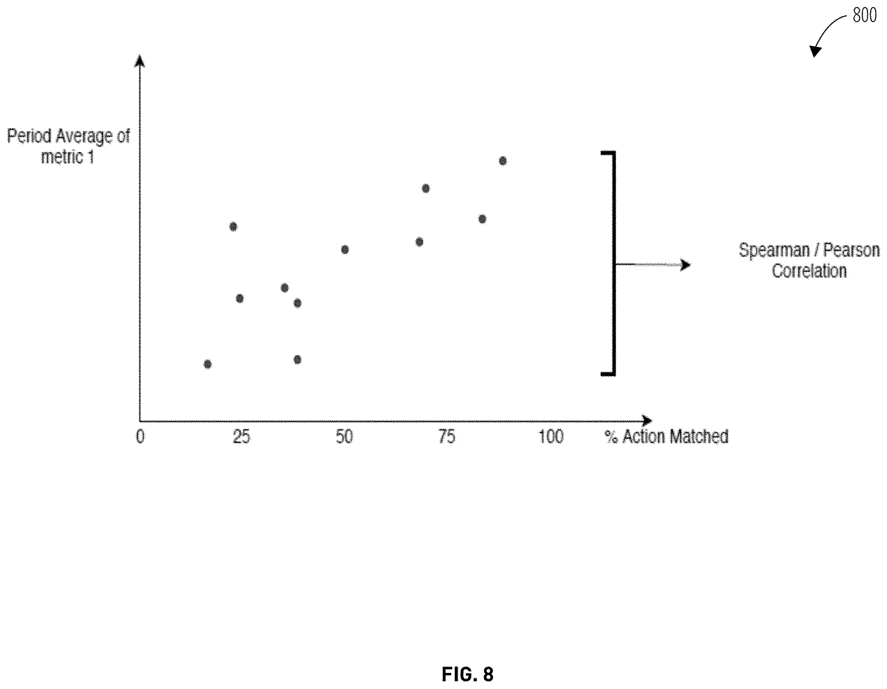

As an example, an important summary statistic is the average of a metric for each period, as shown in FIG. 8. The metric can be an entity that is being optimized, or an entity for evaluating the agent. In some embodiments, the metric can be a reward, which can incorporate information such as product quality, system downtime, costs, etc. In some embodiments, the average of any of the single components may be calculated (e.g. average of system downtime, average of product quality, etc.).

Using this information in a table or scatter plot, an agent is expected to perform similar actions (to that of an operator) when a time period has good average metrics. On the other hand, the agent is expected to perform differently when the average metric for the period is not good (in which case, there will be a lower matching percentage between the actions of the operator and the agent). This relationship can be captured using Pearson correlation coefficient and Spearman's rank-order correlation coefficient. Moreover, looking at the low matching periods, one can inspect whether an agent performs reasonably when it acts differently from the human operator.

Other summary statistics of interest include standard deviation, min, max, and median. When more than one metric is used for evaluation of the agent, the above procedure may be followed.

An example of period summary statistics is illustrated in Table 7.

TABLE 7

| | Start | Total number of | % | Average of | Standard deviation | |
|---|---|---|---|---|---|---|
| Period | date | actions | match | metric 1 | of metric 1 | |
| 1 | 2019 Jun. 1 | 100 | 90 | 0.9 | 0.5 | . . . |
| 2 | 2019 Jul. 1 | 121 | 10 | 0.1 | 0.9 | |
| . . . | . . . | . . . | . . . | . . . | . . . | . . . |

Global Policy Analysis

For each possible action, one can plot a histogram of metrics for each action. With these histograms, an analysis of what the agent's actions in different contexts, can be performed. A histogram of the agent's actions versus the operator's actions provides measure of the reasonableness of the agent's actions.

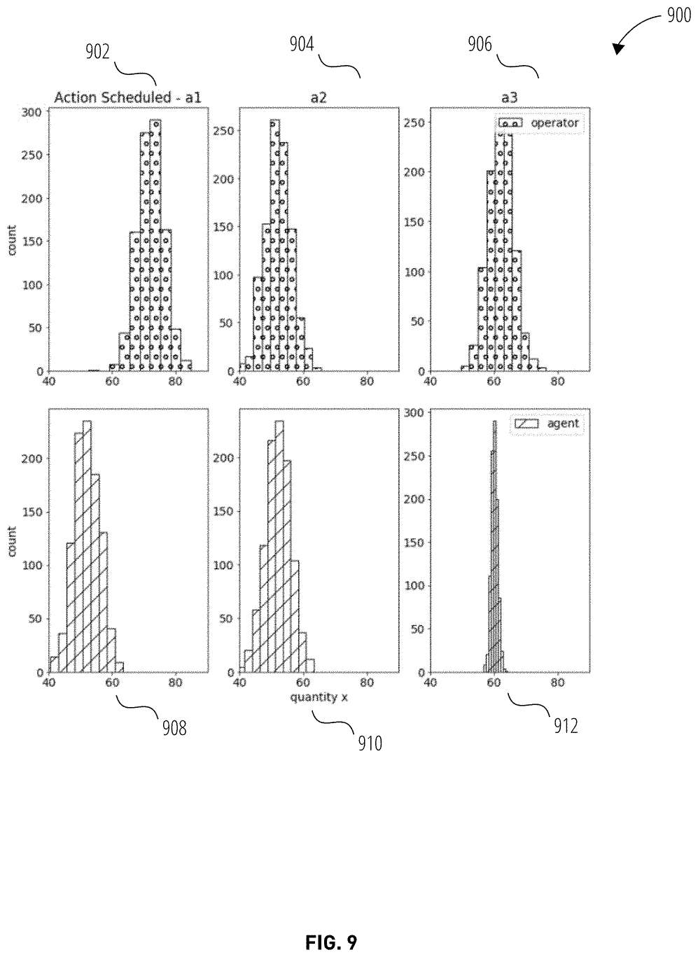

FIG. 9 illustrates a simulated global policy analysis 900, in which pairs of comparative histograms are shown. In each pair, the agent's scheduled actions are compared to an operator's actual actions with respect to a quantity x. Histogram pair 902-908 represents action a₁; histogram pair 904-910 represents action a₂; and histogram pair 906-912 represents action a₃.

With respect to pair 902-908, the agent's scheduling of action a₁ is quite different from that of the operator, as there is hardly any overlap of the respective histograms with respect to x. The agent's recommended action of a₁ occurs towards the lower limit of x, whereas the operator's scheduled action of a₁ occurs towards the upper limit of x. In addition, the maximum count of the operator (about 290) is higher than the maximum count (about 240) of the agent 702. On the other hand, histogram pair 904-910 indicates almost minimal difference regarding the scheduling of action a₂ between the agent and operator with respect to x, with the count being slightly higher for the operator. Finally, histogram pair 906-912 indicates that action a₃ is scheduled by the agent over a smaller range than that of the operator with respect to x. In 906, the operator applies action a₃ at higher values of x (i.e. x>67), whereas the agent does not schedule action a₃ when x>67.

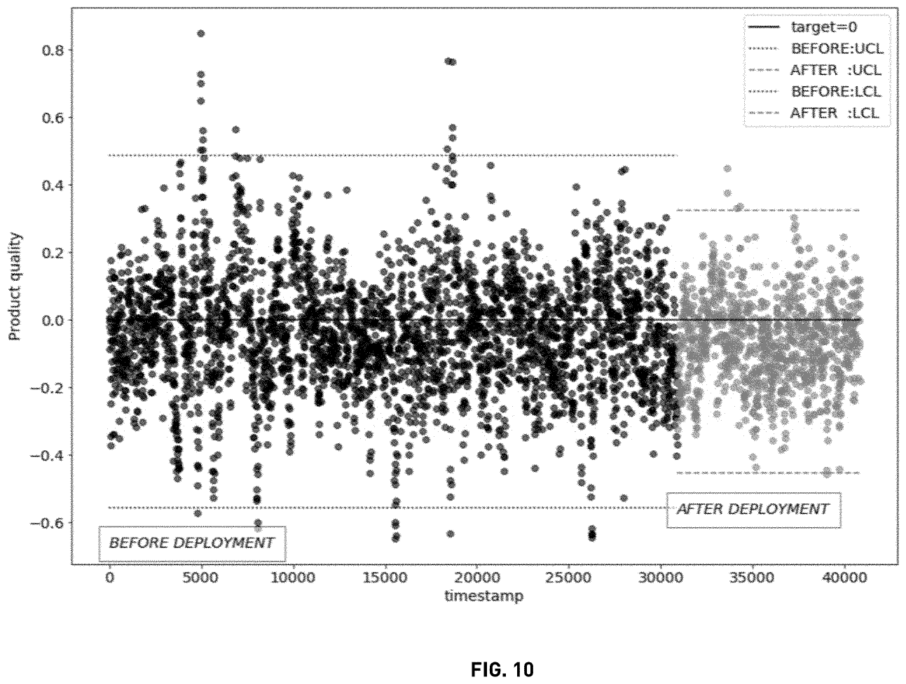

FIG. 10 illustrates a control chart before and after deployment of an RL agent in accordance with one embodiment. The upper control limit (UCL) and lower control limit (LCL) are each calculated as 3 standard deviations away from the mean for the period before and after deployment of the agent. The upper control limit is used in conjunction with the lower control limit to create the range of variability for quality specifications, enabling an operator to provide an optimal level of excellence by adhering to the established guidelines. As can be seen from FIG. 10, since the agent went online (i.e. at timestamp 30875), there was better control of the process—as seen from lower UCL and higher LCL. That is, the range of deviations in the product quality was reduced.

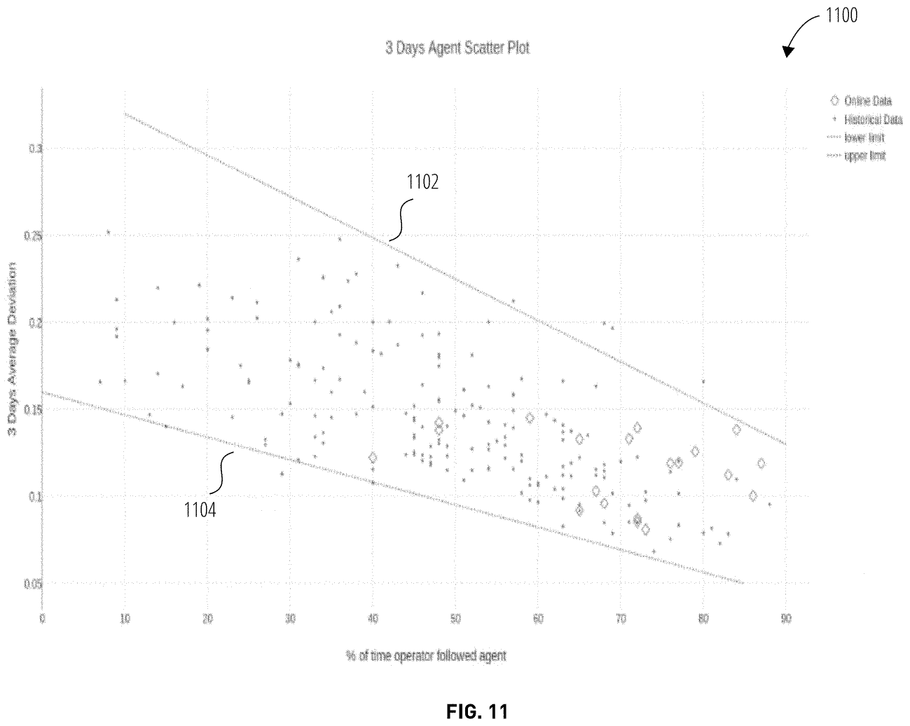

FIG. 11 illustrates a period summary stats analysis, using period summary statistics, for a blast furnace process, in which ores are mixed and combined into molten metal.

In FIG. 11, the historical data is the data that used to train the agent. The online data is the data since the agent went into production. The data is partitioned into 3-day periods and statistics for each 3-day period is calculated and plotted in FIG. 11, which shows that as the agent and operator have more matched actions, the average deviation is decreased. Furthermore, the range in deviation between an upper limit 1102 and lower limit 1104 decreases as the agent and operator actions match. Furthermore, after deployment of the agent, the online data follows a similar trend as the historical data.

Decision Tree

Machine learning has great potential for improving products, processes and research. However, ML algorithms do not explain their predictions, which is often a barrier to the adoption of machine learning.

In contrast, the present method allows for the RL agent to become more “transparent” and easier to adapt by humans; it can also generate business insights. Decision Trees (DTs) are nonparametric supervised learning methods, in which the goal is to create a model that predicts the value of a target variable by learning simple decision rules inferred from the data features. The RL agent behavior can be explained using a shallow DT. The decision tree classifier uses current process states as input and uses the agent's scheduled actions (from a trained model) as output, an example of which is shown in Table 8.

TABLE 8
Decision tree input and output

| Decision Time t | Current Process State Sₜ | Agent Action |
|---|---|---|
| | [S_{t, 1}, S_{t, 2}, . . . , S_{t, p}] | f(pₜ) = \argmaxpₜ |
| 11:03 | [1, . . . , 1] | 1 |
| 11:04 | [2, . . . , 1] | 3 |
| 11:05 | [2, . . . , 2] | 3 |
| . . . | . . . | . . . |

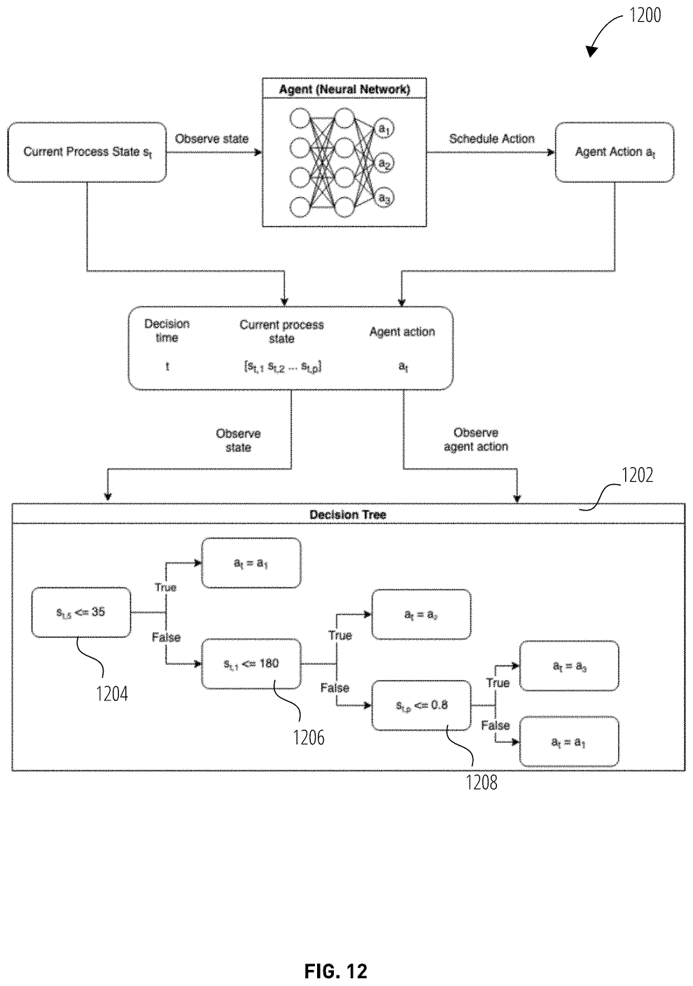

FIG. 12 illustrates a mapping 1200 of a decision tree 1202 in accordance with one embodiment. Based on the input (current process state) and output (agent action), the decision tree 1202 shows decisions based on the value of features. A feature is defined as a particular state at a given time t; that is, the current process state is a sequence (or vector) of features.

In decision tree 1202, a decision 1204 is made with regards to a threshold value of 35 of the fifth feature (i.e. s_{t,5}), in which either action a₁ is taken, or a decision 1206 is made with respect to the first feature (i.e. s_{t,1}). At decision point 1206, either action a₂ is taken, or a decision is made with respect to the third feature (i.e. s_{t,3}), and so on.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand alone program, a component, or other unit suitable for use in a computing environment. A computer program can be deployed to be executed on one computer or can be deployed on multiple computers that are located at one site or distributed across multiple sites and interconnected by a communication network. As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices. The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU). Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive. Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry. To provide for interaction with a user, embodiments of the subject matter described herein can be implemented on a computer having a display device for displaying information to the user and input devices by which the user can provide input to the computer (e.g. a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser. Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”). The computing system can include clients and servers. A client and server are generally remote from each other and typically interact through a communication network. The relationship of client and server arises by virtue of computer programs running on the respective computers and having a client-server relationship to each other.

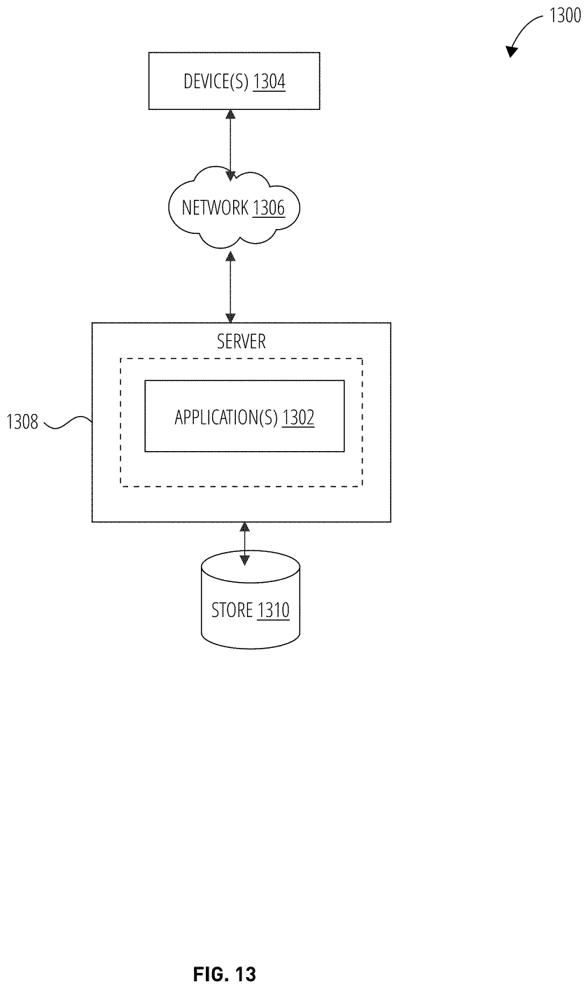

FIG. 13 illustrates a simplified block diagram of a computing system in which various embodiments may be practiced. The computing system may include number of device(s) 1304 (for example, a computing device, a tablet computing device, a mobile computing device, etc.). The device(s) 1304 may be in communication with a distributed computing network 1306. A server 1308 is in communication with the device(s) 1304 over the network 1306. The server 1308 may store one or more application(s) 1302 which may perform routines as described above. The server 1308 may provide the one or more application(s) 1302 to clients. As one example, the server 1308 may be a web server providing one or more application(s) 1302 over the web. The server 1308 may provide the one or more application(s) 1302 over the web to clients through the network 1306. Any of the computing device(s) 1304 may obtain content from the store 1310. Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products. Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
obtaining training data of a process, the training data comprising information about a current process state, an action from a plurality of actions applied to the current process state, a next process state obtained by applying the action to the current process state, a reward based on a metric of the process, the reward depending on the current process state, the action, and the future process state; and a long-term reward comprising the reward and one or more future rewards; and
training a neural network on the training data to provide a recommended probability of each action from the plurality of actions, wherein a policy gradient algorithm adjusts a raw action probability output by the neural network to the recommended probability by incorporating domain knowledge of the process.

2. The method of claim 1, wherein the policy gradient incorporates an imaginary long-term reward of an augmented action to adjust the raw probability.

3. The method of claim 1, wherein the training data further comprises one or more constraints on each action, with each constraint in a form of an action mask.

4. The method of claim 3, wherein the policy gradient incorporates an imaginary long-term reward of an augmented action and the one or more constraints to adjust the raw probability.

5. The method of claim 1, wherein the process is a blast furnace process for production of molten steel, the metric is a chemical composition metric of the molten steel, and the one or more recommended probability of each action relates to operation of a fuel injection rate of the blast furnace.

6. A method for incorporation of a constraint on one or more actions in training of a reinforcement learning module, the method comprising application of an action mask to a probability of each action output by a neural network of the module.

7. A method comprising:
providing an explanation path from an input to an output of a trained neural network comprising application of a decision tree classifier to the input and the output, wherein the input comprises a current process state and the output comprises an action.

8. A method for evaluating a reinforcement learning agent, the method comprising:
partitioning a validation data set into two or more fixed time periods;
for each period, evaluating a summary statistic of a metric for a process; and percentage of occurrences when an action of an operator matches an action of the agent; and
correlating the summary statistic of the metric and percentage across all fixed time periods.
